(19) United States
(12) Patent Application Publication
(10) Pub. No.: US 2026/0289313 A1
(43) Pub. Date: Sep. 24, 2026

(54) SYSTEMS AND METHODS FOR TRAINING ARTIFICIAL INTELLIGENCE AGENTS

(71) Applicant: Salesforce, Inc., San Francisco, CA (US)

(72) Inventors: Jianguo Zhang, San Jose, CA (US); Thai Hoang, Palo Alto, CA (US); Ming Zhu, Palo Alto, CA (US); Zuxin Liu, Palo Alto, CA (US); Tulika Manoj Awalgaonkar, Mountain View, CA (US); Shiyu Wang, Palo Alto, CA (US); Zhiwei Liu, Austin, TX (US); Juan Carlos Niebles Duque, Mountain View, CA (US); Shelby Heinecke, San Francisco, CA (US); Huan Wang, Palo Alto, CA (US); Caiming Xiong, Menlo Park, CA (US)

(21) Appl. No.: 19/286,456

(22) Filed: Jul. 31, 2025

Related U.S. Application Data
(60) Provisional application No. 63/775,875, filed on Mar. 21, 2025.

(51) Int. Cl. G06N 3/082

(52) U.S. Cl. CPC G06N 3/082

(57) ABSTRACT

Embodiments described herein provide methods for building artificial intelligence (AI) agents that efficiently train and deploy neural network models based on their architectural profiles. The approach includes obtaining profile information of a target neural network model, such as architecture characteristics, and determining memory utilization and data communication during a forward pass. Using this information, a database of pretrained neural network models is searched to identify similar models and retrieve associated training configurations, or a default configuration is selected if no close match is found. The target model is then trained using the selected configuration on distributed servers, and upon successful training, the resulting model is deployed as an AI agent to perform actions within a computing environment.

### CROSS REFERENCE(S)

The instant application is a nonprovisional of and claims priority under 35 U.S.C. 119 to U.S. provisional Application No. 63/775,875, filed Mar. 21, 2025, which is hereby expressly incorporated by reference herein in its entirety.

### TECHNICAL FIELD

The embodiments relate generally to machine learning systems for Artificial Intelligence (AI) agents, and more specifically to systems and methods for training artificial intelligence agents.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

AI agents are often built upon LLMs trained to perform complex tasks. Foundation LLMs such as Transformers or LLAMA may be pretrained to perform a wide range of natural language tasks, but often require substantial customization and heavy modifications to support agent-specific data and training. For example, building a medical research agent on GPT-4o to design clinical trials, analyze clinical data and summarize research results would need finetuning with a large corpus of domain-specific data. Such agent construction and finetuning can be costly and largely unscalable.

### BRIEF DESCRIPTION OF THE DRAWINGS

FIG. 1 shows an example operation of an LLM based AI agent, according to embodiments of the present disclosure.

FIG. 2 is a simplified diagram illustrating an AI Agent training framework according to some embodiments.

FIG. 3A is a simplified diagram illustrating a computing device implementing the AI Agent training framework described in FIGS. 1-2, according to some embodiments.

FIG. 3B is a simplified diagram illustrating a neural network structure, according to some embodiments.

FIG. 4 is a simplified block diagram of a networked system suitable for implementing the AI Agent training framework described in FIGS. 1-3B and other embodiments described herein.

FIG. 5 is an example logic flow diagram illustrating a method of building an artificial intelligence (AI) agent to carry out actions on a computing environment based on the framework shown in FIGS. 1-4, according to some embodiments.

FIG. 6 provides a chart illustrating exemplary performance of embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

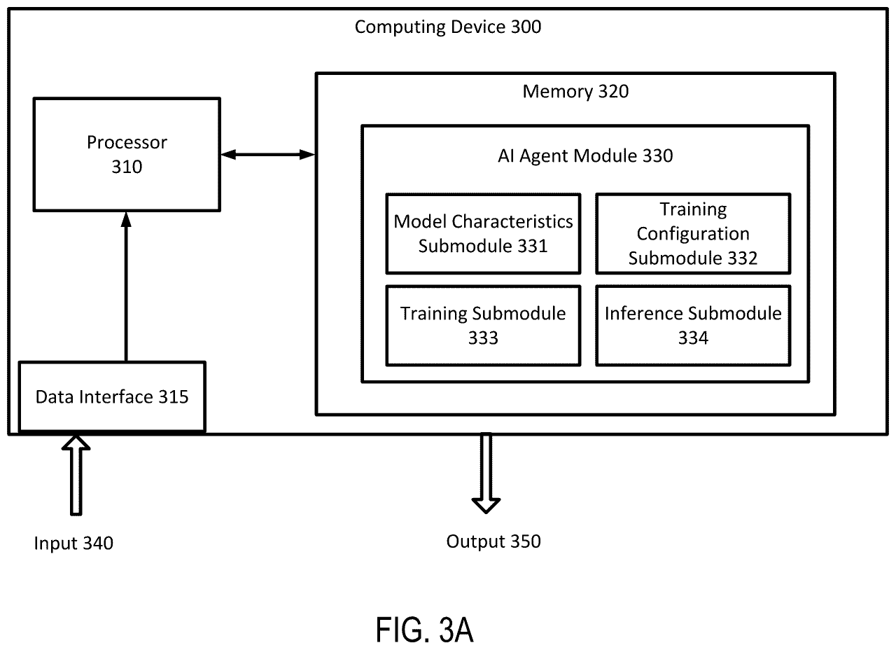

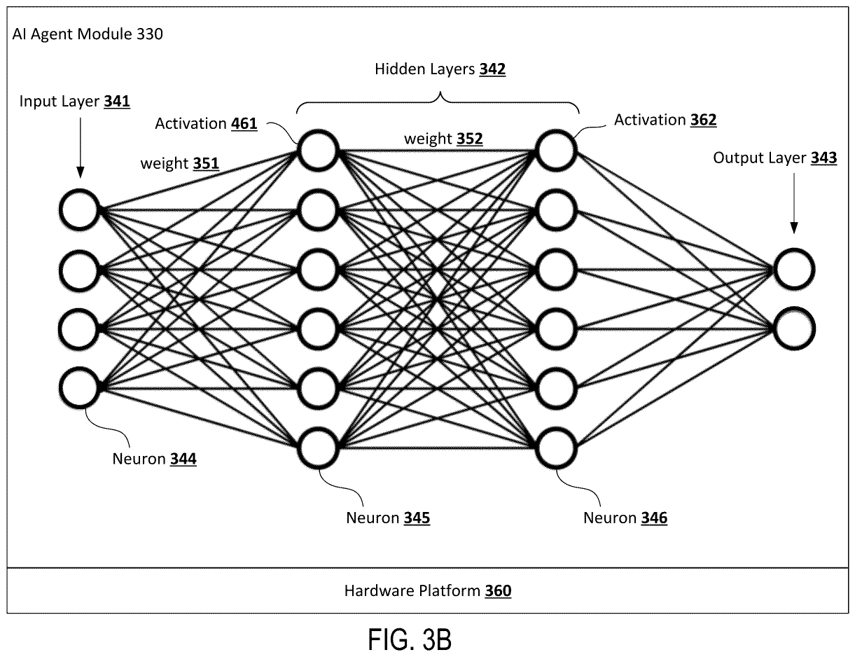

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 3B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

AI agents are often built upon LLMs trained to perform complex tasks. Foundation LLMs such as Transformers or LLAMA may be pretrained to perform a wide range of natural language tasks, but often require substantial customization and heavy modifications to support agent-specific data and training. For example, building a medical research agent on GPT-4o to design clinical trials, analyze clinical data and summarize research results would need finetuning with a large corpus of domain-specific data. Such agent construction and finetuning can be costly and largely unscalable.

Embodiments described herein provide an automated training framework for training of AI agent models using training configurations determined upon the specific model characteristics. For example, a specific model's memory usage requirements, architectural characteristics indicating the amount of communication between different model components, etc. are used to determine how data and/or model parameters are divided (e.g., sharded) across GPUs. Model characteristics may be compared to a number of known models to determine the known model with the most similar profile, and the corresponding training configuration may be selected. If none of the known models are similar enough based on some metric, a baseline default training configuration may be utilized which prioritizes ability to train over efficiency. A user may be notified if the default training configuration is not able to train the provided model.

Models trained via embodiments described herein may include AI-agents which may be configured to respond to queries and perform tasks. In some embodiments, the AI-agent is based on an LLM that generates responses and instructions for performing tasks which may be automatically performed via tools available to the AI agent (e.g., web searching, controlling network configurations, etc.). Large action models (e.g., an AI agent model that is capable of operating effectively across complex, multi-step tasks in diverse environments) may be trained via embodiments described herein. It should be understood that the description of training and inference methods described herein may be applied to various types of neural-network based models.

Embodiments described herein further include a unification of diverse agent trajectories using a unified format, support for a range of training workflows with optimized multi-node distributed setup, and integration of robust preprocessing and real-time verification.

Embodiments described herein provide a number of benefits. For example, by automatically determining training configurations for AI agents based on neural network architecture characteristics and data communication profiles, embodiments enable more efficient allocation of computational and memory resources during both training and inference, thereby reducing hardware requirements and accelerating model development cycles. In another example, the integration of a unified data processing and quality filtering pipeline ensures that only high-quality, semantically consistent agentic trajectories are used for training, which improves model reliability and reduces the risk of learning from noisy or erroneous data. An agentic trajectory refers to the sequence of actions, decisions, and observations made by an AI agent as it interacts with its environment to accomplish specific tasks. These trajectories capture the agent's behavior and learning process, providing valuable data for training and evaluation. In another example, the ability to dynamically profile and match target models with optimal training configurations from a database of pretrained models allows for seamless adaptation to a wide variety of model architectures and deployment environments, minimizing manual intervention and reducing the likelihood of configuration errors that could lead to inefficient training or system failures.

In another example, the extensible and modular framework for distributed training supports near-linear scalability across multiple nodes and GPUs, enabling the training of large action models at industrial scale with significantly higher throughput compared to conventional frameworks. In another example, the technical approach of leveraging both in-context critique filtering and rule-based checks for data quality enables more precise and cost-effective selection of training data, further enhancing model performance and reducing reliance on expensive manual annotation or commercial LLMs. Therefore, with improved performance on distributed, high-throughput, and reliable training of AI Agent models, neural network technology in the field of autonomous agent development and deployment is improved.

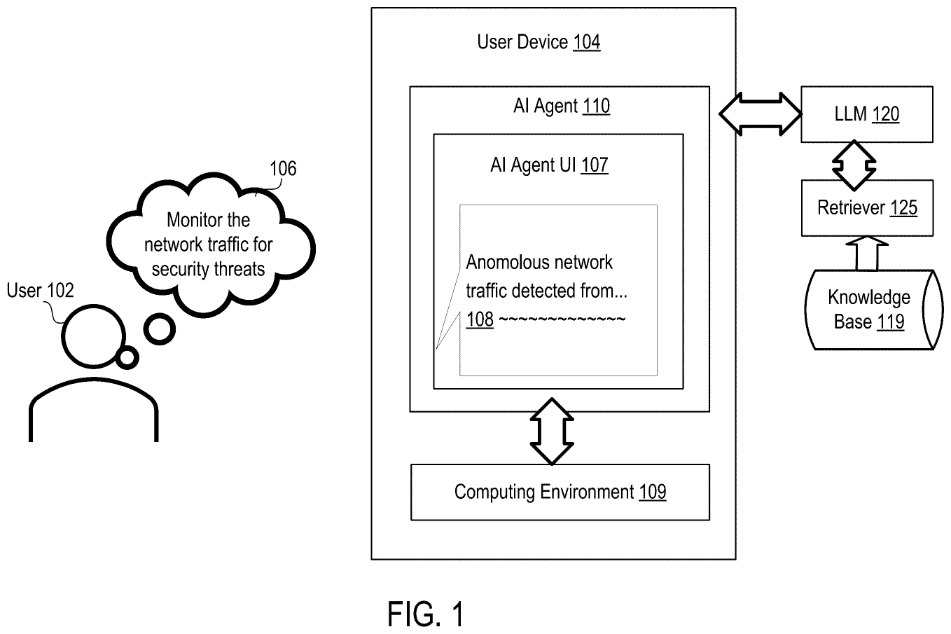

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “Monitor the network traffic for security threats” 106.

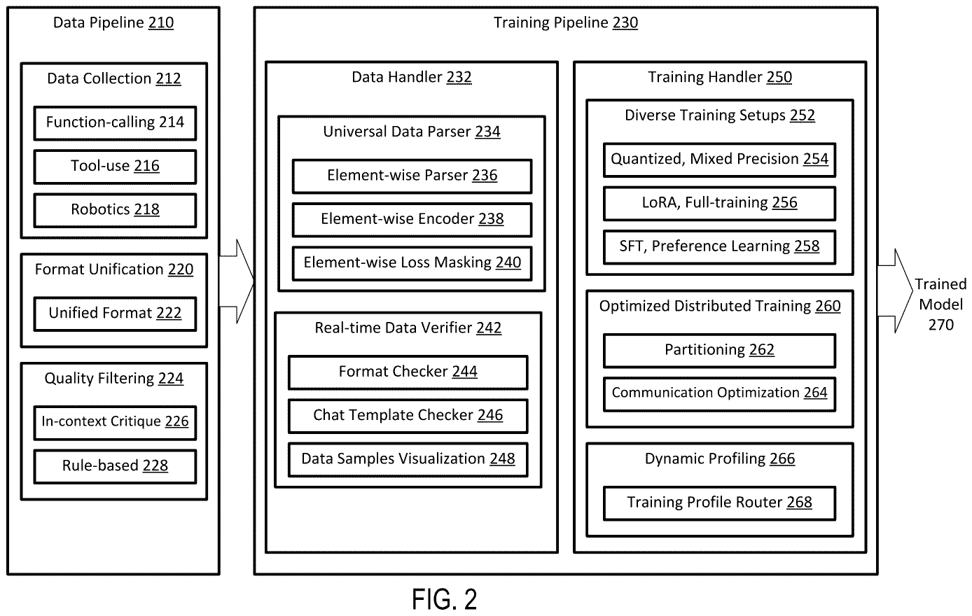

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt. The LLM 120 may operate with a retriever model 125, which retrieves relevant context documents from a knowledge base 119 as a context, to in turn generate a textual response 108 based on an input combining the task request 106, any system prompt and the retrieved context. Additional details on the LLM 120 generating output tokens to form the response 108 may be described in FIGS. 2-3B.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, the AI agent 110 may be installed at, or communicatively coupled to a network gateway or router to monitor network traffic for security threats. In response to a user demand to monitor the network traffic for security threats 106, the LLM 120 may obtain network traffic data, and a predicted result 108 detailing network analysis. Meanwhile, the LLM 120 may output a code script (e.g., a system-level command to the network router) to execute on the computing environment 109 on the user device 104 to monitor network traffic, and/or interface with APIs of other applications to monitor network traffic, and/or the like. For example, the generated code script may be executed at the network router to block the network traffic from a particular IP address for a specified amount of time. Thus, the AI agent actions including generating the text response 108, generating the code script for execution and the consequently blocking of network traffic according to the code script, may form an agentic trajectory corresponding to the user request 106.

In this way, the LLM-based AI agent may facilitate end-to-end workflow to automate the task request 106. However, existing training methods for training of AI agents and finetuning can be costly and largely unscalable. Embodiments described herein provide highly scalable and efficient methods for training of AI, as further described in FIGS. 2-5 below.

FIG. 2 is a simplified diagram illustrating an AI Agent training framework according to some embodiments. Framework 200 provides an end-to-end, modular, and extensible system for constructing, processing, and training large action models (LAMs) for autonomous agents (e.g., AI agents). Framework 200 is designed to address the challenges of heterogeneous agentic data, scalable training, and robust quality control, and is composed of two primary subsystems: data pipeline 210 and training pipeline 230, which work together to produce a trained model 270 suitable for deployment in agentic environments.

Data pipeline 210 is responsible for ingesting, standardizing, and filtering diverse agentic data sources to produce high-quality, training-ready datasets. The modular structure of data pipeline 210 ensures extensibility, scalability, and compatibility with a wide range of agent environments and models, allowing researchers and practitioners to adapt the framework to new domains and data modalities as needed. Within data pipeline 210, data collection 212 aggregates raw agent trajectories from multiple sources, including function-calling 214, tool-use 216, and robotics 218. These sources represent a broad spectrum of agentic behaviors, from programmatic API invocations to embodied robotic actions. The datasets collected by data collection 212 vary significantly in structure and components, which poses substantial challenges for LAM training, as the data may include single-step responses, multi-step reasoning, and multi-turn conversations, each with different role configurations and contextual dependencies.

To address the heterogeneity of agentic data, format unification 220 standardizes all collected trajectories into a unified format 222. Unified format 222 is natively compatible with modern chat-based LLM APIs and HuggingFace-style chat templates. Unlike previous approaches, which required non-trivial conversion and error fixing overhead, unified format 222 modularizes agent trajectories into semantically grounded and model-compatible components, such as task instructions, available tools, and user-agent exchanges (including tool calls and execution results). This design supports a wide range of interaction formats, including Alpaca-style (input, output) pairs, ShareGPT-style multi-turn dialogues, and general chat-based workflows, thereby minimizing data transformation overhead and enabling direct use in common fine-tuning pipelines and runtime LLM interfaces.

Unified format 222 replaces the traditional step-based schema with a conversation-centric structure that mirrors the message-passing paradigm of modern LLM APIs. In this format, each agentic trajectory is represented as a list of messages, where each message is assigned a specific role such as system, user, assistant, or tool, enabling clear delineation of conversational turns and tool interactions. Tool calls are explicitly embedded within assistant messages using a dedicated tool_calls field, while tool responses are captured as separate messages with the role tool and are linked to their corresponding calls via unique tool_call_id references. This structure not only streamlines the representation of complex agentic workflows, including multi-turn tool use and user follow-ups, but also ensures seamless compatibility with chat templates used by APIs like OpenAI and HuggingFace. The unified format further includes fields for task instructions, available tools (with detailed descriptions and parameter schemas), and optional few-shot examples, providing rich context for both training and inference. By modularizing agentic data in this way, unified format 222 facilitates plug-and-play integration with diverse LLM architectures, supports flexible loss masking and training objectives, and significantly reduces the engineering burden associated with data conversion and augmentation.

Quality filtering 224 ensures that only high-quality, reliable trajectories are included in the training dataset. Quality filtering 224 comprises in-context critique 226 and rule-based 228 components. In-context critique 226 leverages LLM-based evaluators, augmented with curated exemplars that illustrate common failure cases and preferred critique behaviors, to provide fine-grained, human-aligned evaluations of trajectory quality. This approach addresses the limitations of off-the-shelf LLM evaluators, which tend to produce overly confident or median-biased scores and often fail to detect subtle or context-dependent hallucinations. By incorporating curated exemplars and, where possible, fine-tuning open-source models using agent critique data, in-context critique 226 reduces reliance on commercial LLMs and improves the accessibility and cost-effectiveness of quality filtering. Rule-based 228 complements the critique pipeline by systematically identifying and removing trajectories with errors such as missing function calls, incorrect function names or arguments, and hallucinated agent actions. The effectiveness of quality filtering 224 is validated through human verification, which demonstrates high agreement between the automated filtering decisions and human judgments.

The output of data pipeline 210 is a curated, standardized dataset. The dataset may include single-turn and multi-turn trajectories. The dataset may include calls to multiple different APIs and/or web domains. The dataset may include programmatic tool-use sequences, embodied agent interactions, and both single-and multi-turn tasks, all represented in unified format 222. This breadth and diversity of data ensures that the resulting models are robust and generalizable across a wide range of agentic scenarios.

Training pipeline 230 receives the processed data from data pipeline 210 (or via another source) and orchestrates the fine-tuning and optimization of large language models for agentic tasks. Training pipeline 230 is composed of data handler 232 and training handler 250, each of which contains specialized subcomponents to maximize flexibility, efficiency, and control.

Data handler 232 manages the parsing, encoding, and validation of training data. Universal data parser 234 is designed to handle the complexity and diversity of agentic data by performing element-wise parsing 236, element-wise encoding 238, and element-wise loss masking 240. Each part of the conversation history is parsed as independently as possible, while still adhering to the chat template, which allows for fine-grained control over the training process and supports different training objectives. This design accelerates experimentation and speeds up model development, giving researchers full control over the parsing, encoding, and loss masking processes, and making it easy to fine-tune agentic models for specific tasks.

Real-time data verifier 242 ensures data integrity and compliance throughout the training pipeline. Format checker 244 flags data instances with missing fields or incorrect structures. Chat template checker 246 verifies that every conversation fits the provided chat template. Data samples visualization 248 presents “before-and-after” views of each data entry at every stage: before and after preprocessing, template application, and encoding, enabling users to validate that their data complies with the expected format. The real-time data verifier 242 may dynamically run these checks throughout the training pipeline, minimizing the risk of unexpected behaviors during training, which results in more reliable model performance.

Training handler 250 provides comprehensive support for a wide range of training setups and optimizations. The set of training configurations which are selected as part of method 500 may include training configurations described herein with reference to training handler 250. Diverse training setups 252 include support for quantized and mixed precision 254, LoRA and full-training 256, as well as supervised fine-tuning (SFT) and preference learning 258. This flexibility allows framework 200 to adapt to varying training requirements and computational resource constraints, supporting both lightweight and full-scale training regimes. For example, Low-Rank Adaptation (LoRA) is a parameter-efficient fine-tuning technique that injects trainable low-rank matrices into specific layers of a pre-trained model, such as the attention projections, while keeping the majority of the original model weights frozen. This approach dramatically reduces the number of parameters that need to be updated during training, making it especially well-suited for environments with limited computational resources or memory constraints. By leveraging LoRA, users can achieve effective adaptation of large models to new tasks with significantly lower hardware requirements and faster training times compared to full-model fine-tuning.

Optimized distributed training 260 optimizes the model training across distributed devices for high efficiency and scalability, incorporating partitioning 262 and communication optimization 264 to reduce inefficiencies in layer-to-layer interactions and communications between experts under Mixture of Experts settings. Training handler 250 also supports parallelization and sharding strategies, such as those offered by DeepSpeed, ensuring compatibility with industry-standard training practices and enabling seamless scalability to industrial-scale training clusters. In some embodiments, sharding divides the model parameters and training data across multiple devices or nodes, allowing each to process a subset of the workload in parallel. This not only reduces memory usage per device but also accelerates training by distributing computation more evenly. By supporting both tensor and pipeline sharding, the framework ensures efficient utilization of available hardware and minimizes communication overhead during large-scale training.

Dynamic profiling 266 further enhances training efficiency by automatically routing model checkpoints to optimized configurations based on the architecture and current resource situation, as managed by training profile router 268. This automation eliminates the need for labor-intensive manual tuning, allowing researchers to achieve higher efficiency with less effort and ensuring that the training process is tailored to the specific characteristics of the target model.

In some embodiments, framework 200 maintains a repository of predefined configuration profiles, each tailored to different model architectures and resource constraints, including a default profile that prioritizes runnability to maximize the likelihood of successful training even under suboptimal conditions. When a new model is received for training, the system first evaluates the model's memory requirements and analyzes the expected communication patterns between its internal components, such as attention blocks or expert modules. Using this information, the framework compares the model's characteristics to those of the stored profiles, seeking the closest match that can deliver optimal performance given the current hardware environment. If no sufficiently similar configuration is found (e.g., when the anticipated communication bandwidth between critical blocks exceeds a predefined threshold), the system falls back to the default profile, which is designed to favor stability and runnability over peak efficiency. Should the default profile also prove incompatible with the available resources, for example due to insufficient memory or network bandwidth, the framework notifies the user of the failure, enabling them to adjust their setup or model selection accordingly. This process ensures that training is always attempted under the most suitable configuration available, while providing clear feedback in cases where resource limitations prevent successful execution.

Throughout the training process, data pipeline 210 provides high-quality, standardized training data to training pipeline 230, which in turn processes, validates, and optimizes the data for model fine-tuning. The output of training pipeline 230 is a trained model 270, which is ready for deployment as an AI agent capable of performing complex, multi-step tasks across diverse environments. By integrating these components and processes, framework 200 significantly lowers the barrier to AI Agent development and provides a scalable foundation for further innovation in both research and industry applications.

### Computer and Network Environment

FIG. 3A is a simplified diagram illustrating a computing device implementing the AI Agent training framework described in FIGS. 1-2, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3B.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for AI Agent module 330 that may be used to implement and/or emulate the systems and models, and/or to implement any of the methods described further herein. AI Agent module 330 may receive input 340 such as an input training data (e.g., data generated by data pipeline 210) via the data interface 315 and generate an output 350 which may be a response, action, API call, etc.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as a query, from a user via the user interface.

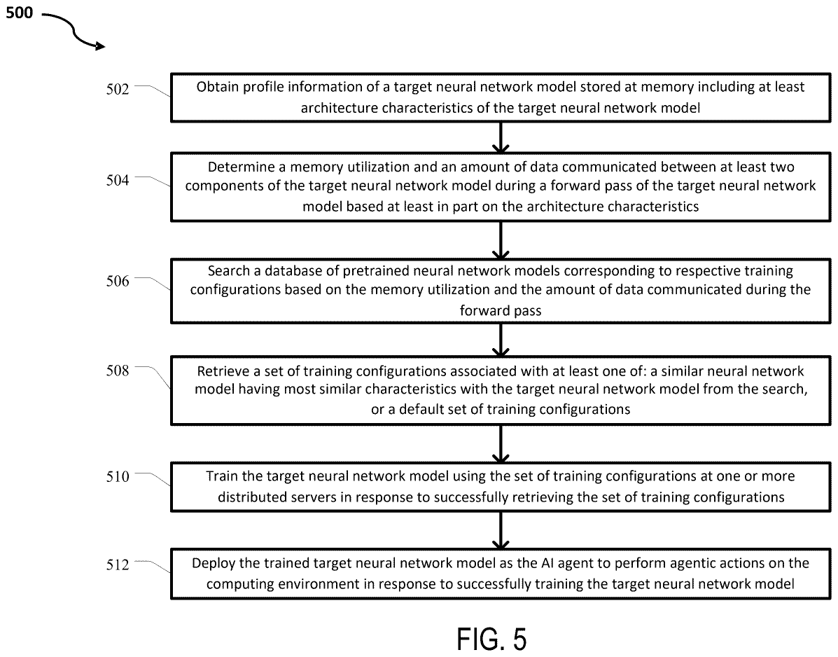

In some embodiments, the AI Agent module 330 is configured to perform the AI Agent training and/or inference described herein. The AI Agent module 330 may further include model characteristics submodule 331 configured to determine characteristics of a target AI agent model to be trained (e.g., memory utilization and/or communication bandwidths between model components). The AI Agent module 330 may further include training configuration submodule 232 configured to select training configurations as described here, especially with respect to FIG. 5. The AI Agent module 330 may further include training submodule 333 configured to train the AI agent model according to the selecting training configuration as described herein. The AI Agent module 330 may further include inference submodule 334 configured to utilize the trained AI agent model. This may include the AI agent being utilized as a customer service agent, for communication network management, or a number of various applications as described herein.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the AI Agent module 330 described in FIG. 3A, according to some embodiments. In some embodiments, the AI Agent module 330 and/or one or more of its submodules 331-334 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as a query. The number of nodes (neurons) in the input layer 341 may be determined by the dimensionality of the input data (e.g., the length of a vector of the query). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the AI Agent module 330 receives an input 340 of a query and transforms the input into an output 350 of an action and/or response. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI Agent module 330 and/or one or more of its submodules 331-334 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be an LLM, and/or the like.

In one embodiment, the AI Agent module 330 and its submodules 331-334 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the AI Agent module 330 and its submodules 331-334 may be implemented by hardware, software and/or a combination thereof. For example, the AI Agent module 330 and its submodules 331-334 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

For example, to deploy the AI Agent module 330 and its submodules 331-334 and/or any other neural network models described herein onto hardware platform 360, the neural network based modules 330 and its submodules 331-334 may be optimized for deployment by converting it to a suitable format, such as ONNX or TensorRT, to improve performance and compatibility. Next, depending on the size and workload requirements for modules 330 and its submodules 331-334, hardware types may be chosen for deployment, e.g., processing capacity, GPU memory size, and/or the like. Frameworks and drivers for the chosen hardware 360 frameworks and drivers may thus be installed, such as PyTorch, TensorFlow, or CUDA, to support the hardware platform 360. Then, weights and parameters of the AI Agent module 330 and its submodules 331-334 may be loaded to the hardware 360. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI Agent module 330 and its submodules 331-334 may be deployed as a service, then they may be integrated with an API endpoint, using tools like Flask, FastAPI, or a cloud platform serverless services, and is accessible by a remote user via a network.

In another embodiment, some or all of layers 341, 342, 343 and/or neurons 342, 345, 346, and operations there between such as activations 361, 362, and/or the like, of the AI Agent module 330 and its submodules 331-334 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI Agent module 330 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based AI Agent module 330 and one or more of its submodules 331-334 may be trained by iteratively updating the underlying parameters (e.g., weights 351, 352, etc., bias parameters and/or coefficients in the activation functions 361, 362 associated with neurons) of the neural network based on the loss function. For example, during forward propagation, the training data such as that generated via data pipeline 210, are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding ground truth response) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based AI Agent module 330 and one or more of its submodules 331-334 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

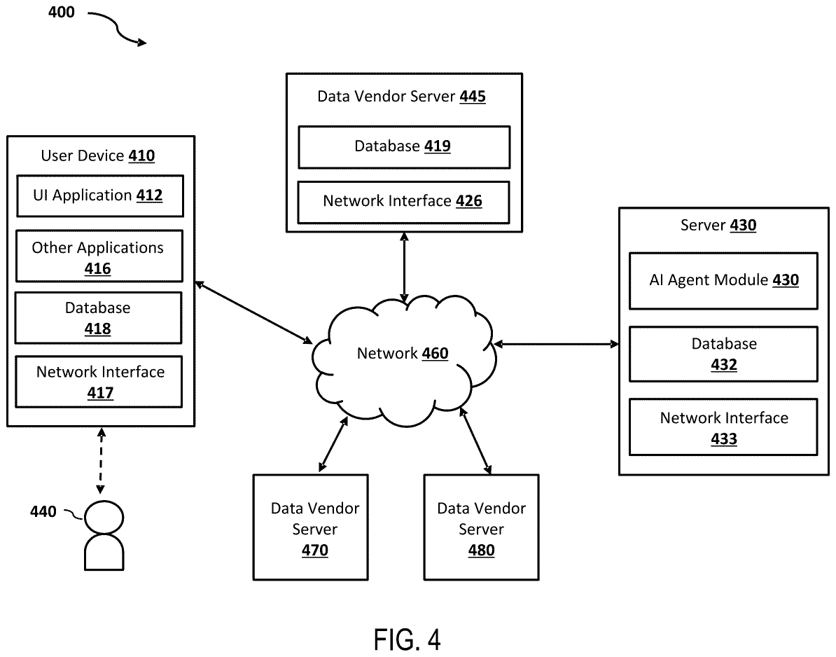

In some embodiments, AI Agent module 330 and its submodules 331-334 may be housed at a centralized server (e.g., computing device 300) or one or more distributed servers. For example, one or more of AI Agent module 330 and its submodules 331-334 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen queries.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in optimized training of diverse AI agent models.

FIG. 4 is a simplified block diagram of a networked system 400 suitable for implementing the AI Agent training framework described in FIGS. 1-3B and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating a response from the server 430 and display the message via the UI application 412. In other embodiments, user device 410 may include additional or different modules having specialized hardware and/or software as required.

In one embodiment, UI application 412 may communicatively and interactively generate a UI for an AI agent implemented through the AI Agent module 330 (e.g., an LLM agent) at server 430. In at least one embodiment, a user operating user device 410 may enter a user utterance, e.g., via text or audio input, such as a question, uploading a document, and/or the like via the UI application 412. Such user utterance may be sent to server 430, at which AI Agent module 330 may generate a response via the process described in FIGS. 1-3B. The AI Agent module 330 may thus cause a display of responses and/or the results of actions at UI application 412 and interactively update the display in real time with the user utterance.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view responses.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including agent trajectories to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the AI Agent module 330 and its submodules described in FIG. 3A. In some implementations, AI Agent module 330 may receive data from database 419 at the data vendor server 445 via the network 460 to generate responses. The generated responses may also be sent to the user device 410 for review by the user 440 via the network 460.

In one embodiment, an AI agent implementing the AI Agent module 330 and its submodules described in FIG. 3A may be built based on an LLM as described in FIG. 3B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the AI Agent module 330 and its submodules described in FIG. 3A may be implemented as a cloud-based AI agent which may be accessed by user device 410 via a chatbot application, a web application, customer support or SaaS applications. In another implementation, a client-side AI agent component may be delivered from the server 430 to user device 410 for local installation such that the client-side AI agent may be installed and runs directly on the user's device. Such local AI agent on the user device 410 may be available offline to adapt to privacy-sensitive applications. In another implementation, the AI agent implementing the AI Agent module 330 and its submodules described in FIG. 3A may adopt a hybrid cloud and client-based structure to balance computing speed, cost and privacy. For example, a local AI agent may handle basic AI queries locally, but complex queries may be sent to server 430 to process.

The database 432 may be stored in a transitory and/or non-transitory memory of the server 430. In one implementation, the database 432 may store data obtained from the data vendor server 445. In one implementation, the database 432 may store parameters of the AI Agent module 330. In one implementation, the database 432 may store previously generated repsonses and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

FIG. 5 is an example logic flow diagram illustrating a method 500 of building an artificial intelligence (AI) agent to carry out actions on a computing environment based on the framework shown in FIGS. 1-4, according to some embodiments. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the AI Agent module 330 (e.g., FIGS. 3A and 4) that performs the training and/or inference of an AI agent model as described herein.

In some embodiments, method 500 is performed by a system such as computing device 300, user device 410, server 430, or another device or combination of devices. Inputs (e.g., queries) may be received via a data interface such as data interface 315, network interface 417, network interface 433, or via a data interface that is integrated with a device. For example UI Application 412 may receive user inputs via a text input interface (e.g., keyboard), audio input (e.g., microphone), video interface (e.g., camera), or other interface for receiving user inputs (e.g., a mouse or touch display).

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, the system obtains profile information of a target neural network model stored at memory including at least architecture characteristics of the target neural network model. In some embodiments, the architecture characteristics may include the number of layers, type of layers, parameter count, and other structural details relevant to the model's operation.

At step 504, the system determines a memory utilization and an amount of data communicated between at least two components of the target neural network model during a forward pass of the target neural network model based at least in part on the architecture characteristics.

At step 506, the system searches a database of pretrained neural network models corresponding to respective training configurations based on the memory utilization and the amount of data communicated during the forward pass.

At step 508, the system retrieves a set of training configurations associated with at least one of: a similar neural network model having most similar characteristics with the target neural network model from the search, or a default set of training configurations. In some embodiments, the retrieving the set of training configurations includes determining the similar neural network model has a memory utilization within a first predefined threshold amount of difference from the memory utilization of the target neural network model. In some embodiments, the retrieving the set of training configurations includes determining the similar neural network model has an amount of data communicated between at least two components within a second predefined threshold amount of difference from the amount of data communicated between at least two components of the target neural network model.

In some embodiments, determining the similar neural network model has a memory utilization within a first predefined threshold amount includes determining the memory utilization of the similar neural network model is greater than the memory utilization of the target neural network model by the first predefined threshold amount. In some embodiments, determining the similar neural network model has a memory utilization within a first predefined threshold amount includes determining the memory utilization of the similar neural network model is less than the memory utilization of the target neural network model by the first predefined threshold amount.

In some embodiments, determining the similar neural network model has an amount of data communicated between at least two components within a second predefined threshold amount includes determining the similar neural network model has the amount of data communicated between at least two components greater than the amount of data communicated between at least two components of the target neural network model by the first predefined threshold amount. In some embodiments, determining the similar neural network model has an amount of data communicated between at least two components within a second predefined threshold amount includes determining the similar neural network model has the amount of data communicated between at least two components less than the amount of data communicated between at least two components of the target neural network model by the first predefined threshold amount.

In some embodiments, retrieving the set of training configurations includes retrieving the set of training configurations associated with the default set of training configurations in response to none of the pretrained neural network models of the database of pretrained neural network models having characteristics within a predefined threshold of similarity to the target neural network model. In some embodiments, the system further determines the retrieving the set of training configurations was not successful in response to the default set of training configurations including insufficient memory or computation resources. In some embodiments, the system further indicates via a user interface that the training was not successful. In some embodiments, the set of training configurations includes a data sharding configuration, a model parameter sharding configuration, or a training data batch size configuration. Training configurations in some embodiments may further include any of the training configurations described with respect to training handler 250 (e.g., LoRA training configuration, partitioning, quantization, etc.).

At step 510, the system trains the target neural network model using the set of training configurations at one or more distributed servers in response to successfully retrieving the set of training configurations.

At step 512, the system deploys the trained target neural network model as the AI agent to perform agentic actions on the computing environment in response to successfully training the target neural network model. Deployment may involve packaging the trained model, configuring runtime environments, and integrating the agent with the target application or system.

In some embodiments, method 500 is applicable in a variety of applications. For example, the task request received by a trained AI agent model may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 500, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 500 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

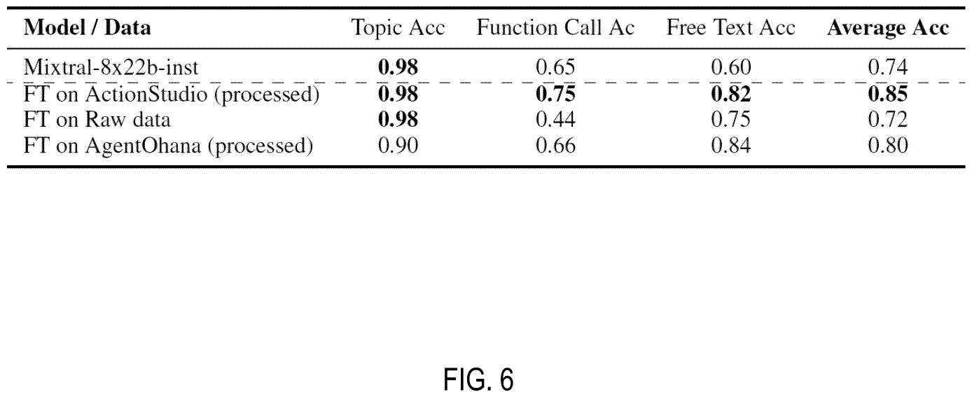

FIG. 6 provides a chart illustrating exemplary performance of embodiments described herein. Specifically, FIG. 6 depicts a comparative chart summarizing the accuracy of various model and data pipeline configurations on the CRM Agent Benchmark. The chart highlights the performance of models fine-tuned using different data processing pipelines, including ActionStudio-processed (which represents an embodiment of training data generated via training pipeline 210 as described herein), with raw and AgentOhana-processed agent trajectories as baseline models. The metrics displayed include topic identification accuracy, function call accuracy, free-text response accuracy, and the overall average accuracy. Notably, the ActionStudio-processed pipeline achieves the highest scores across all metrics, with significant improvements in function call and free-text accuracy compared to both the raw and AgentOhana-processed baselines. This chart underscores the effectiveness of training via embodiments described herein in enhancing model performance for realistic CRM agent scenarios.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for building an artificial intelligence (AI) agent to carry out actions on a computing environment, comprising:
obtaining profile information of a target neural network model stored at memory including at least architecture characteristics of the target neural network model;
determining a memory utilization and an amount of data communicated between at least two components of the target neural network model during a forward pass of the target neural network model based at least in part on the architecture characteristics;
searching a database of pretrained neural network models corresponding to respective training configurations based on the memory utilization and the amount of data communicated during the forward pass;
retrieving a set of training configurations associated with at least one of:
a similar neural network model having most similar characteristics with the target neural network model from the search, or
a default set of training configurations;
training the target neural network model using the set of training configurations at one or more distributed servers in response to successfully retrieving the set of training configurations; and
deploying the trained target neural network model as the AI agent to perform agentic actions on the computing environment in response to successfully training the target neural network model.

2. The method of claim 1, wherein the retrieving the set of training configurations includes at least one of:
determining the similar neural network model has a memory utilization within a first predefined threshold amount of difference from the memory utilization of the target neural network model, or
determining the similar neural network model has an amount of data communicated between at least two components within a second predefined threshold amount of difference from the amount of data communicated between at least two components of the target neural network model.

3. The method of claim 2, wherein the determining the similar neural network model has a memory utilization within a first predefined threshold amount includes at least one of:
determining the memory utilization of the similar neural network model is greater than the memory utilization of the target neural network model by the first predefined threshold amount, or
determining the memory utilization of the similar neural network model is less than the memory utilization of the target neural network model by the first predefined threshold amount.

4. The method of claim 2, wherein determining the similar neural network model has an amount of data communicated between at least two components within a second predefined threshold amount includes at least one of:
determining the similar neural network model has the amount of data communicated between at least two components greater than the amount of data communicated between at least two components of the target neural network model by the first predefined threshold amount, or
determining the similar neural network model has the amount of data communicated between at least two components less than the amount of data communicated between at least two components of the target neural network model by the first predefined threshold amount.

5. The method of claim 1, wherein the retrieving the set of training configurations includes:
retrieving the set of training configurations associated with the default set of training configurations in response to none of the pretrained neural network models of the database of pretrained neural network models having characteristics within a predefined threshold of similarity to the target neural network model.

6. The method of claim 5, further comprising:
determining the retrieving the set of training configurations was not successful in response to the default set of training configurations including insufficient memory or computation resources; and
indicating via a user interface that the training was not successful.

7. The method of claim 1, wherein the set of training configurations includes at least one of:
a data sharding configuration;
a model parameter sharding configuration; or
a training data batch size configuration.

8. A system for building an artificial intelligence (AI) agent to carry out actions on a computing environment, the system comprising:
a memory that stores the AI agent and a plurality of processor executable instructions; and
one or more hardware processors that read and execute the plurality of processor-executable instructions from the memory, wherein the plurality of processor-executable instructions are configurable to cause the system to perform operations comprising:
obtaining profile information of a target neural network model stored at memory including at least architecture characteristics of the target neural network model;
determining a memory utilization and an amount of data communicated between at least two components of the target neural network model during a forward pass of the target neural network model based at least in part on the architecture characteristics;
searching a database of pretrained neural network models corresponding to respective training configurations based on the memory utilization and the amount of data communicated during the forward pass;
retrieving a set of training configurations associated with at least one of:
a similar neural network model having most similar characteristics with the target neural network model from the search, or
a default set of training configurations;
training the target neural network model using the set of training configurations at one or more distributed servers in response to successfully retrieving the set of training configurations; and
deploying the trained target neural network model as the AI agent to perform agentic actions on the computing environment in response to successfully training the target neural network model.

9. The system of claim 8, wherein the retrieving the set of training configurations includes at least one of:
determining the similar neural network model has a memory utilization within a first predefined threshold amount of difference from the memory utilization of the target neural network model, or
determining the similar neural network model has an amount of data communicated between at least two components within a second predefined threshold amount of difference from the amount of data communicated between at least two components of the target neural network model.

10. The system of claim 9, wherein the determining the similar neural network model has a memory utilization within a first predefined threshold amount includes at least one of:
determining the memory utilization of the similar neural network model is greater than the memory utilization of the target neural network model by the first predefined threshold amount, or
determining the memory utilization of the similar neural network model is less than the memory utilization of the target neural network model by the first predefined threshold amount.

11. The system of claim 9, wherein determining the similar neural network model has an amount of data communicated between at least two components within a second predefined threshold amount includes at least one of:
determining the similar neural network model has the amount of data communicated between at least two components greater than the amount of data communicated between at least two components of the target neural network model by the first predefined threshold amount, or
determining the similar neural network model has the amount of data communicated between at least two components less than the amount of data communicated between at least two components of the target neural network model by the first predefined threshold amount.

12. The system of claim 8, wherein the retrieving the set of training configurations includes:
retrieving the set of training configurations associated with the default set of training configurations in response to none of the pretrained neural network models of the database of pretrained neural network models having characteristics within a predefined threshold of similarity to the target neural network model.

13. The system of claim 12, the operations further comprising:
determining the retrieving the set of training configurations was not successful in response to the default set of training configurations including insufficient memory or computation resources; and
indicating via a user interface that the training was not successful.

14. The system of claim 8, wherein the set of training configurations includes at least one of:
a data sharding configuration;
a model parameter sharding configuration; or
a training data batch size configuration.

15. A non-transitory machine-readable medium comprising a plurality of instructions, executable by one or more processors, wherein the plurality of instructions are configurable to cause the one or more processors to perform operations comprising:
obtaining profile information of a target neural network model stored at memory including at least architecture characteristics of the target neural network model;
determining a memory utilization and an amount of data communicated between at least two components of the target neural network model during a forward pass of the target neural network model based at least in part on the architecture characteristics;
searching a database of pretrained neural network models corresponding to respective training configurations based on the memory utilization and the amount of data communicated during the forward pass;
retrieving a set of training configurations associated with at least one of:
a similar neural network model having most similar characteristics with the target neural network model from the search, or
a default set of training configurations;
training the target neural network model using the set of training configurations at one or more distributed servers in response to successfully retrieving the set of training configurations; and
deploying the trained target neural network model as the AI agent to perform agentic actions on the computing environment in response to successfully training the target neural network model.

16. The non-transitory machine-readable medium of claim 15, wherein the retrieving the set of training configurations includes at least one of:
determining the similar neural network model has a memory utilization within a first predefined threshold amount of difference from the memory utilization of the target neural network model, or
determining the similar neural network model has an amount of data communicated between at least two components within a second predefined threshold amount of difference from the amount of data communicated between at least two components of the target neural network model.

17. The non-transitory machine-readable medium of claim 16, wherein the determining the similar neural network model has a memory utilization within a first predefined threshold amount includes at least one of:
determining the memory utilization of the similar neural network model is greater than the memory utilization of the target neural network model by the first predefined threshold amount, or
determining the memory utilization of the similar neural network model is less than the memory utilization of the target neural network model by the first predefined threshold amount.

18. The non-transitory machine-readable medium of claim 16, wherein determining the similar neural network model has an amount of data communicated between at least two components within a second predefined threshold amount includes at least one of:
determining the similar neural network model has the amount of data communicated between at least two components greater than the amount of data communicated between at least two components of the target neural network model by the first predefined threshold amount, or
determining the similar neural network model has the amount of data communicated between at least two components less than the amount of data communicated between at least two components of the target neural network model by the first predefined threshold amount.

19. The non-transitory machine-readable medium of claim 15, wherein the retrieving the set of training configurations includes:
retrieving the set of training configurations associated with the default set of training configurations in response to none of the pretrained neural network models of the database of pretrained neural network models having characteristics within a predefined threshold of similarity to the target neural network model.

20. The non-transitory machine-readable medium of claim 19, the operations further comprising:
determining the retrieving the set of training configurations was not successful in response to the default set of training configurations including insufficient memory or computation resources; and
indicating via a user interface that the training was not successful.
